(19) United States
(12) Patent Application Publication
(10) Pub. No.: US 2014/0059164 A1
(43) Pub. Date: Feb. 27, 2014

(54) APPARATUS AND METHOD FOR MANAGING TERMINAL DEVICE

(71) Applicant: FUJITSU LIMITED, Kawasaki-shi (JP)

(72) Inventors: Takuro SAITO, Kawasaki (JP); Hideyuki NAGATOSHI, Kawasaki (JP); MASAKI MUKOUCHI, Machida (JP); Jun SOMEKAWA, Yokosuka (JP)

(73) Assignee: FUJITSU LIMITED, Kawasaki-shi (JP)

(21) Appl. No.: 13/947,791

(22) Filed: Jul. 22, 2013

(30) Foreign Application Priority Data
Aug. 22, 2012 (JP) 2012-183639

(51) Int. Cl. H04L 29/08

(52) U.S. Cl. CPC H04L 67/10
USPC 709/217

(57) ABSTRACT

A management apparatus includes: a determination unit configured to determine whether or not terminal device identification information that is included in received terminal information is correct based on whether or not communication that uses communication module identification information of a terminal device including storage device identification information, included in the terminal management information, that is identical to storage device identification information included in the received terminal information and that corresponds to a terminal device other than a terminal device specified by terminal device identification information included in the received terminal information is established; and an update unit configured to update the terminal management information according to the received terminal information when the determination unit determines that the terminal device identification information included in the received terminal information is correct.

### CROSS-REFERENCE TO RELATED APPLICATION

This application is based upon and claims the benefit of priority of the prior Japanese Patent Application No. 2012-183639, filed on Aug. 22, 2012, the entire contents of which are incorporated herein by reference.

### FIELD

The embodiments discussed herein are related to a management apparatus, a management method, and a program for managing a terminal device.

### BACKGROUND

An information processing system is known that deletes data or prevents access to a HDD (Hard Disk Drive) through wireless communications from a remote place in order to prevent data leakage.

FIG. 1 illustrates the outline sequence of an information processing system that prevents data leakage.

The information processing system 100 illustrated in FIG. 1 includes an administrator terminal 110, a management server 120, and a terminal device 130. Although FIG. 1 illustrates only one terminal device 130 for simplicity, the information processing system 100 may include a plurality of terminal devices. There are connections through networks or the like in such a manner that communications can be performed between the administrator terminal 110 and the management server 120 and between the management server 120 and the terminal device 130.

The management server 120 stores, in a storage device (not illustrated), terminal management information 121 including, for each terminal device, a PCID (Personal Computer Identification) stored in a main board that is mounted on a terminal device, a PSN (Phone Serial Number) stored in a communication module that is mounted on the terminal device, and a HDDID (Hard Disk Drive ID) stored in a HDD that is mounted on the terminal device. The management server 120 may display the terminal management information 121 on a WEB page provided by the management server 120.

When, for example, the terminal device 130 has been stolen or lost, the administrator selects through the administrator terminal 110 the PCID, e.g., “aa” in FIG. 1, of the terminal device 130 whose data is to be deleted, from the terminal management information 121 displayed on a WEB page provided by the management server 120.

The management server 120 transmits a data deletion instruction to the terminal device 130 whose data is to be deleted through the telephone line of the PSN of the terminal device 130 identified by the selected PCID, e.g., PSN “070-0000-0001”, which corresponds to PCID “aa” illustrated in FIG. 1. At this time, the management server 120 specifies the HDDID of the HDD whose data is to be deleted, e.g., HDDID “11”, which corresponds to PCID “aa” in FIG. 1.

When the terminal device 130 receives the data deletion instruction from the management server 120, the terminal device 130 executes the deletion of data stored in the HDD having the HDDID specified by the management server 120 among HDDs included in the terminal device 130.

As a related art, a peripheral device management apparatus is known that manages through a LAN a plurality of peripheral devices connected to the LAN and that inherits information before replacement of a peripheral device for which only a LAN card was replaced. (For example, Japanese Laid-open Patent Publication No. 2002-118574)

### SUMMARY

According to an aspect of the embodiments, a management apparatus that manages information related to a plurality of terminal devices. The management apparatus includes: a storage unit configured to store terminal management information including, for each of the plurality of terminal devices, terminal device identification information that is included in a main board of a terminal device and that is used for identifying the terminal device, communication module identification information that is included in a communication module of a terminal device and that is used for identifying the communication module, and storage device identification information that is included in a storage device of a terminal device and that is used for identifying the storage device; a reception unit configured to receive, from one of the plurality of terminal devices, terminal information including terminal device identification information, communication module identification information, and storage device identification information that are included in a main board, a communication module, and a storage device of the terminal device, respectively; a determination unit configured to determine whether or not terminal device identification information that is included in received terminal information is correct based on whether or not communication that uses communication module identification information of a terminal device including storage device identification information, included in the terminal management information, that is identical to storage device identification information included in the received terminal information and that corresponds to a terminal device other than a terminal device specified by terminal device identification information included in the received terminal information is established; and an update unit configured to update the terminal management information according to the received terminal information when the determination unit determines that the terminal device identification information included in the received terminal information is correct, and configured to discard the received terminal information when the determination unit determines that the terminal device identification information included in the received terminal information is not correct.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates the outline sequence of an information processing system that prevents data leakage;

FIG. 2 illustrates operations of the information processing system after the communication module mounted on the terminal device has been replaced with a maintenance component;

FIG. 3 illustrates problems caused when a wrong PCID is written to a new main board;

FIG. 4 illustrates a process of checking a wrong PCID;

FIG. 5 illustrates a configuration example of an information processing system that includes a management server;

FIG. 6 illustrates an example of a configuration of a terminal device;

FIG. 7 illustrates an example of a configuration of the management server;

FIG. 8 illustrates an example of terminal information;

FIG. 9 illustrates an example of terminal management information;

FIG. 10 illustrates an outline of the maintenance operation of the terminal device in the information processing system;

FIG. 11 illustrates an example of an update process of the terminal management information;

FIG. 12 illustrates the configurations of terminal devices, the terminal management information stored in the management server, and the terminal information received from the terminal device with respect to case 1;

FIG. 13 illustrates the configurations of terminal devices, the terminal management information stored in the management server, and the terminal information received from the terminal device with respect to case 2;

FIG. 14 illustrates the configurations of terminal devices, the terminal management information stored in the management server, and the terminal information received from the terminal device with respect to case 3;

FIG. 15 illustrates the configurations of terminal devices, the terminal management information stored in the management server, and the terminal information received from the terminal device with respect to case 4;

FIG. 16 illustrates an example of a message that the terminal device displays on a display device during a process of updating the terminal management information;

FIG. 17 illustrates an example of a message that the terminal device displays on the display device when the process of updating the terminal management information has been terminated normally;

FIG. 18 and FIG. 19 illustrate examples of a messages that the terminal device displays on the display device when the terminal device has received a request to reconfirm a PCID from the management server; and

FIG. 20 illustrates an example of a WEB page provided by the management server.

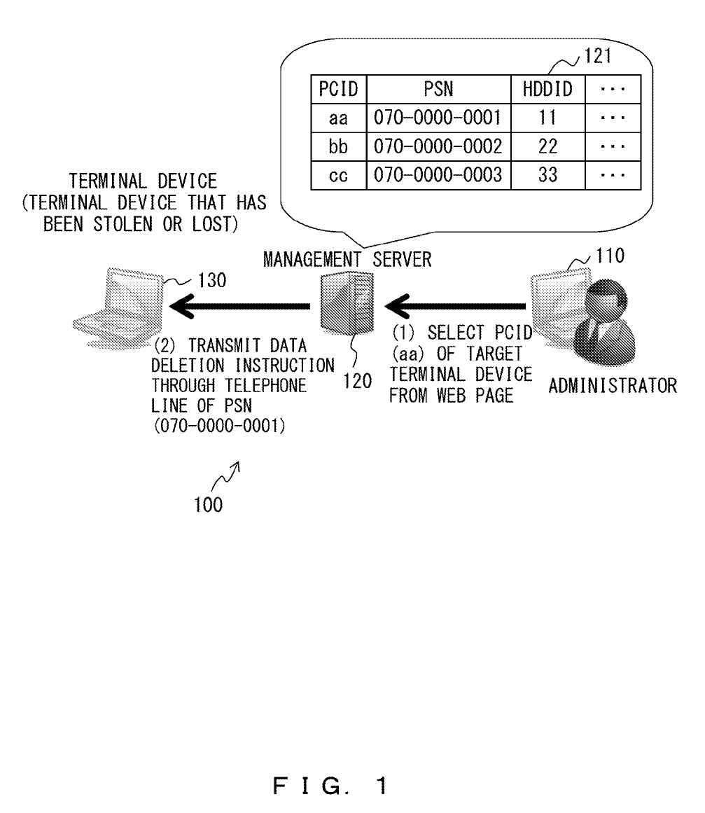

### DESCRIPTION OF EMBODIMENTS

When a terminal device has failed, a CE (Customer Engineer) replaces a failed component with a maintenance component. For example, in a case where the main board, the HDD, or the communication module mounted on the terminal device is replaced, the PCID (Personal Computer ID), the HDDID (Hard Disc Drive ID), or the PSN (Phone Serial Number) corresponding to the replaced component is also changed. Accordingly, the terminal device may transmit terminal information including the PCID, the HDDID or the PSN of the terminal device to a management server after the maintenance operation.

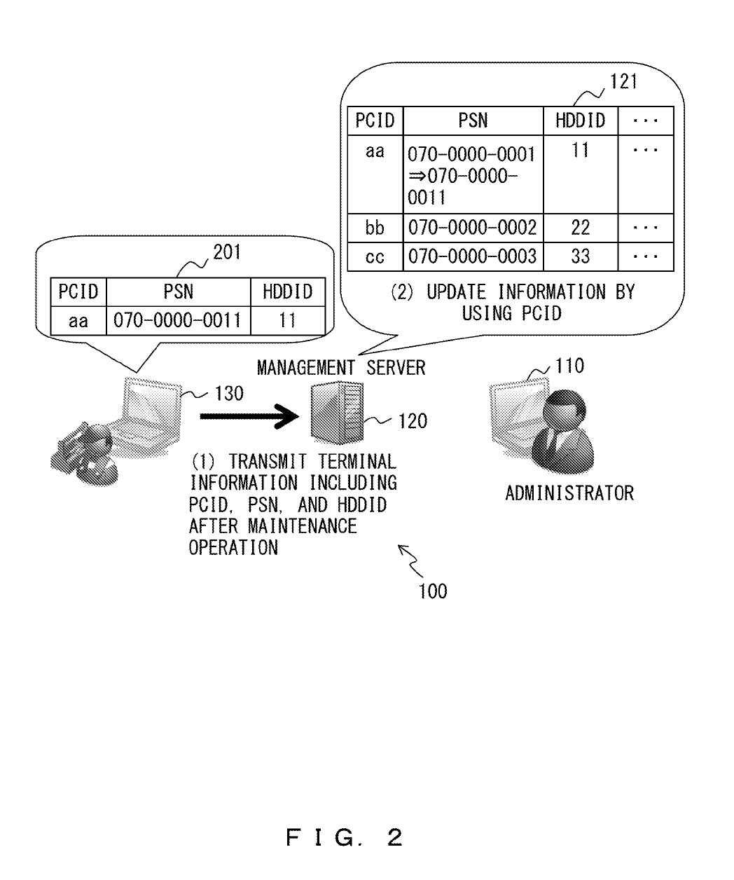

FIG. 2 illustrates operations of an information processing system 100 after the communication module mounted on the terminal device 130 has been replaced with a maintenance component.

After the replacement of the communication module, the terminal device 130 detects that the communication module has been replaced for maintenance when, for example, it is activated. When the terminal device 130 has detected the replacement of the communication module, the terminal device 130 transmits, to the management server 120, the terminal information 201 including the PSN stored in the new communication module that was replaced for maintenance.

When the terminal information 201 has been received from the terminal device 130, the management server 120 reflects the contents of the terminal information 201 in the terminal management information 121 stored in the management server 120. In FIG. 2, the management server 120 has received from the terminal device 130 the terminal information 201 including PSN “070-0000-0011” that was newly changed. In such a case, the management server 120 updates, from “070-0000-0001” to “070-0000-0011”, the PSN that corresponds to PCID “aa” of the terminal device 130 in the terminal management information 121.

As described above, when the communication module or the like of the terminal device 130 has been replaced with a maintenance component, the terminal management information 121 stored in the management server 120 is updated. Accordingly, even after the communication module or the like of the terminal device 130 has been replaced with a maintenance component, the administrator can delete data stored in the HDD mounted on the terminal device 130 by selecting a target terminal device from the terminal management information 121 on the WEB page 121 of the management server 120.

When the main board of the terminal device 130 is replaced for maintenance, the PCID of the main board before the maintenance replacement is written to the new main board. This is because the PCID is used for identifying the terminal devices 130. However, it is sometimes difficult to automatically copy a PCID from a failed main board to a new main board, depending upon the types of failure of the main board. In such a case, the CE writes manually the PCID of the main board before the maintenance replacement to the new main board. In such a case, there is a possibility that the CE writes a wrong PCID to the new main board. In such a case, the problems described below will occur.

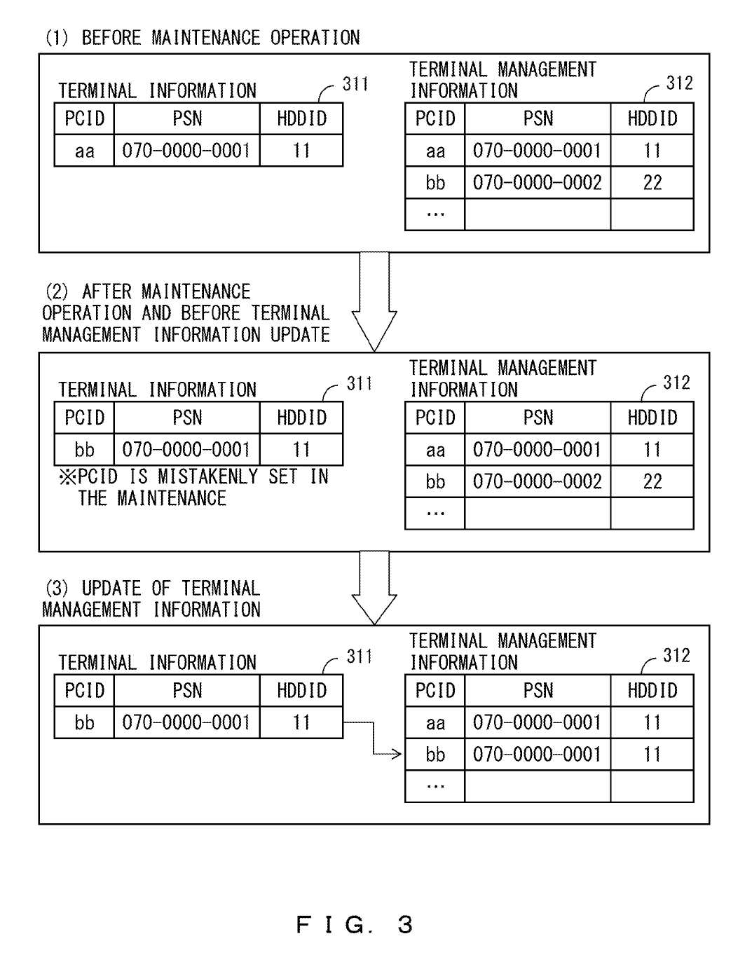

FIG. 3 illustrates problems caused when a wrong PCID is written to a new main board. For simplicity, FIG. 3 only illustrates the terminal information 201 of the terminal device 130 and the terminal management information 121 of the management server 120 before the maintenance operation. Also, (1)-(3) in FIG. 3 correspond to (1)-(3) described below, respectively.

“(1)” denotes terminal information 311 of the terminal device 130 and terminal management information 312 of the management server 120 before the maintenance operation. The terminal information 311, denoted by (1), indicates that the main board having PCID “aa”, the communication module having PSN “070-0000-0001”, and the HDD having HDDID “11” are included in the terminal device 130.

“(2)” denotes the terminal information 311 of the terminal device 130 and the terminal management information 312 of the management server 120 after the maintenance operation and before the updating of the terminal management information. When the CE replaces a main board and mistakenly sets the PCID of the main board after the maintenance operation to “bb” instead of “aa”, which is the PCID before the maintenance operation, the PCID in the terminal information 311 becomes “bb”, as represented by (2).

“(3)” denotes the terminal information 311 of the terminal device 130 and the terminal management information 312 of the management server 120 after the updating of the terminal management information. When the terminal information 311 is reported to the management server 120 from the terminal device 130, the management server 120 in some cases reflects in the terminal management information 312 the terminal information 311, including a PCID that was set mistakenly in (2). When, for example, the terminal information having PCID “bb” already exists in the terminal management information 312, the terminal information 311 of the terminal device 130 is reflected in the terminal information having PCID “bb” that already exists in the terminal management information 312.

When the terminal management information 312 has been updated in accordance with the terminal information 311, including a PCID that was set mistakenly as described above, problems such as the following may for example occur. The administrator selects, through the administrator terminal 110, PCID “bb” as a terminal device, which is a data deletion target, from the terminal management information 312 displayed on a WEB page provided by the management server 120. In such a case, the management server 120 gives a data deletion instruction to the terminal device having the communication module with PSN “070-0000-0001” that corresponds to PCID “bb” in the terminal management information 312, i.e., the terminal device that had PCID “aa” before the maintenance operation.

In view of the above problem, the management server 120 confirms whether or not PSN in the terminal information 311 and PSNs of PCIDs other than a PCID in the terminal information 311 included in the terminal management information 312 are identical before updating the terminal management information 312. When there is an identical PSN, the management server 120 determines that a PCID in the terminal information 311 is wrong, and skips the updating. The management server 120 reports to the administrator terminal 110, the terminal device 130, and the like the fact that reconfirmation of PCIDs is requested. In such a case, a CE, when he or she receives communication from the administrator or the like, confirms PCIDs so as to set the right PCID.

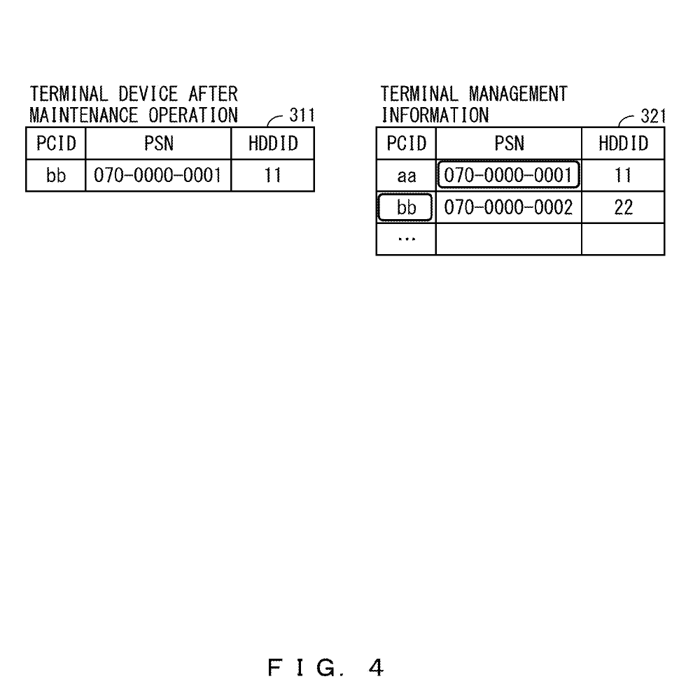

However, maintenance operations sometimes require replacement of both the main board and the communication module mounted on a terminal device. In such a case, accompanying the replacement of a communication module, the PSN also becomes a new PSN, which is different from a PSN before the replacement, and this prevents the PCID in the terminal information 311 being detected as being wrong in the process illustrated in FIG. 4.

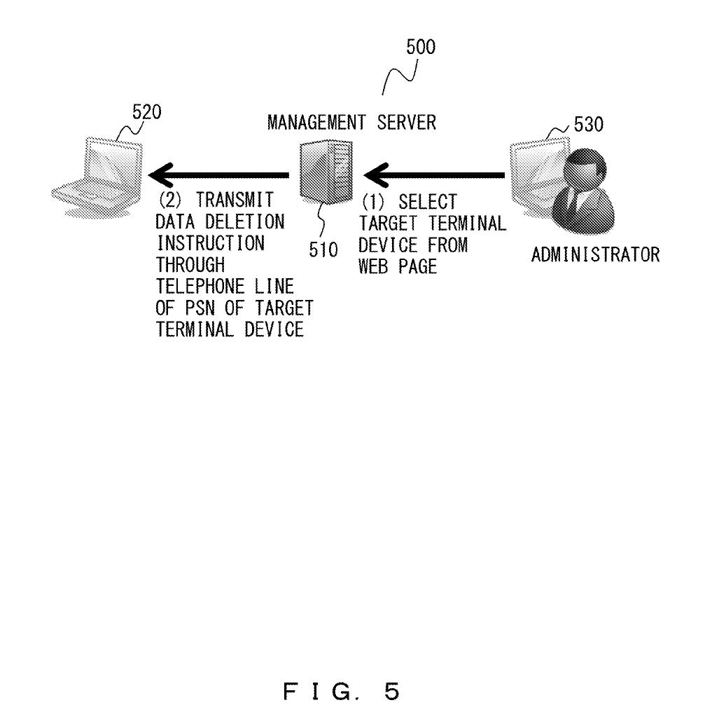

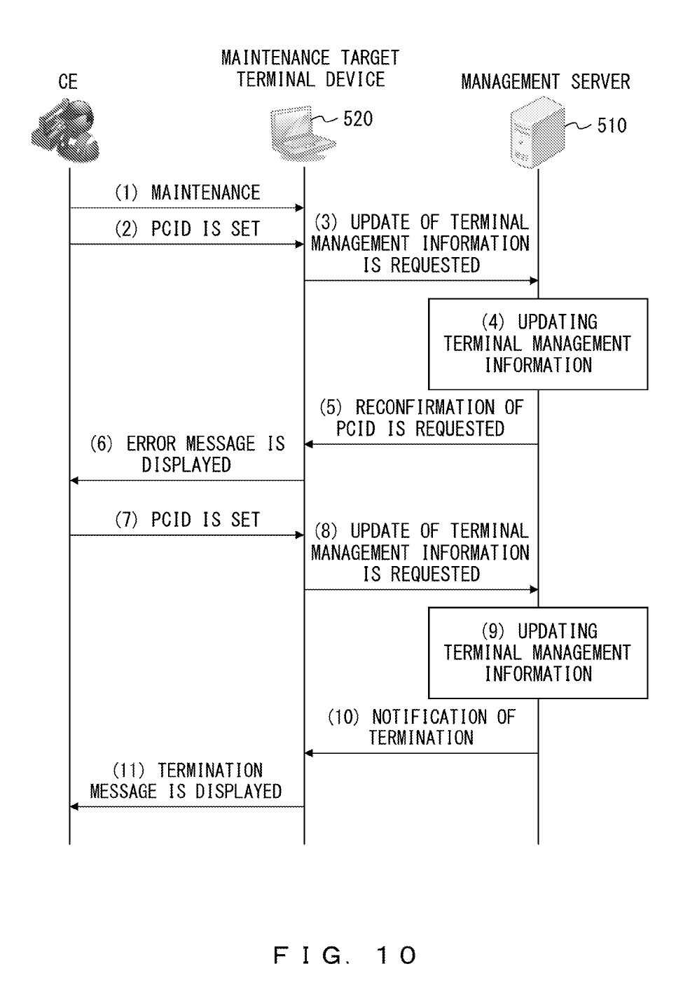

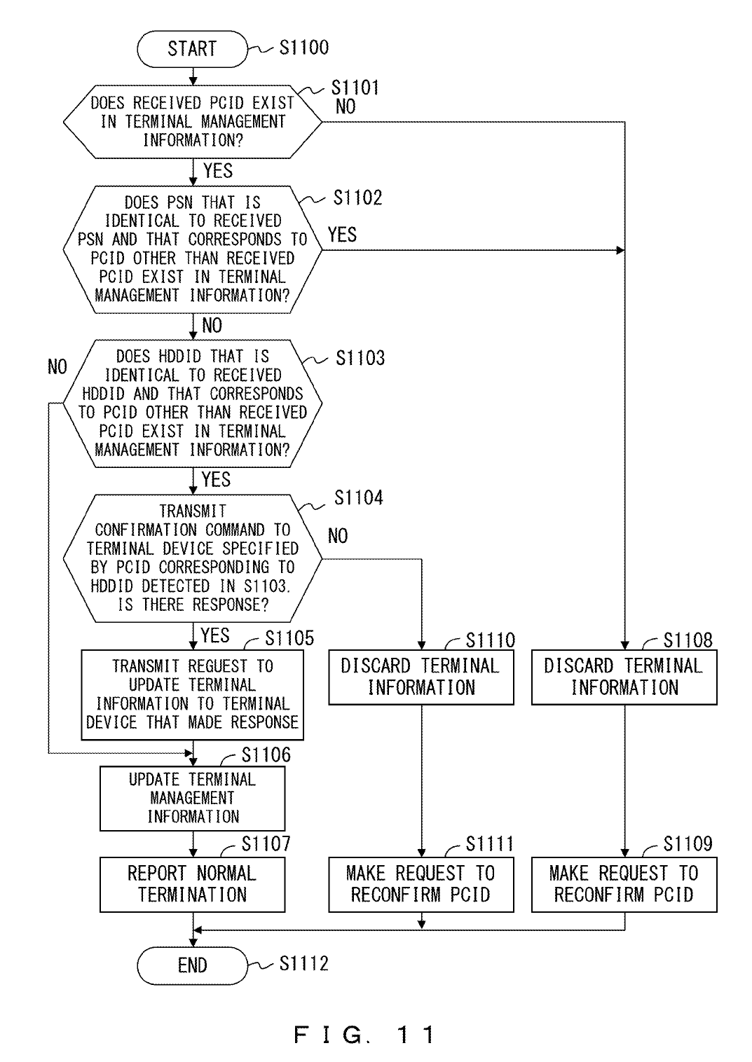

Hereinafter, embodiments of the present invention will be explained by referring to FIGS. 5-20. Note that the embodiments described below are only exemplary, and are not intended to exclude various alterations or technical applications that are not described below. In other words, the present embodiments may be implemented with various alterations, such as by combining the respective examples, without departing from the spirit of the invention. Also, the process procedures represented in the form of flowcharts in FIG. 10 and FIG. 11 are not intended to limit the order of processes. Accordingly, the orders of processes may be changed if possible.

FIG. 5 illustrates a configuration example of an information processing system 500 that includes a management server 510.

The information processing system 500 includes the management server 510 and a plurality of terminal devices. The management server 510 and the plurality of terminal devices are connected in such a manner that communications can be performed through a network. Also, the management server 510 and the plurality of terminal devices may be connected in such a manner that communications can be performed through telephone lines. Although FIG. 5 for simplicity illustrates only one terminal device, this is not intended to limit to one the number of terminal devices included in the information processing system 500. In the present example, an arbitrary one of the plurality of terminal devices included in the information processing system 500 is referred to as a “terminal device 520”.

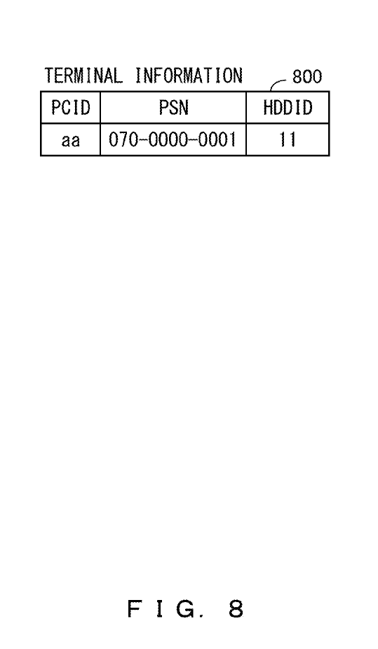

The management server 510 is an information processing apparatus that manages the terminal device 520. The management server 510 receives, from the terminal device 520, information related to the terminal device 520 such as, for example, terminal information 800, which will be described later. The terminal information 800 includes a PCID, a PSN, and a HDDID that are respectively included in a main board 610, a communication module 620, and a HDD 630, which will be described later, included in the terminal device 520. A specific example of the terminal information 800 will be illustrated in FIG. 8.

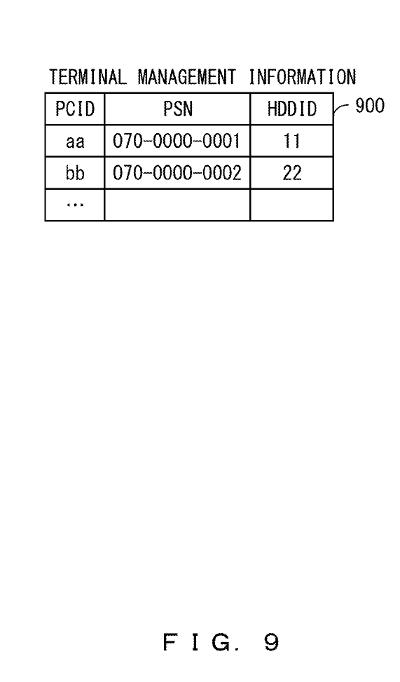

The management server 510 stores terminal management information 900 including the terminal information 800 of each terminal device in, for example, a HDD 705, which will be described later. A specific example of the terminal management information 900 will be illustrated in FIG. 9. When the management server 510 receives the terminal information 800 from the terminal device 520, the management server 510 performs an updating process in which the contents of the received terminal information 800 are reflected in the terminal management information 900.

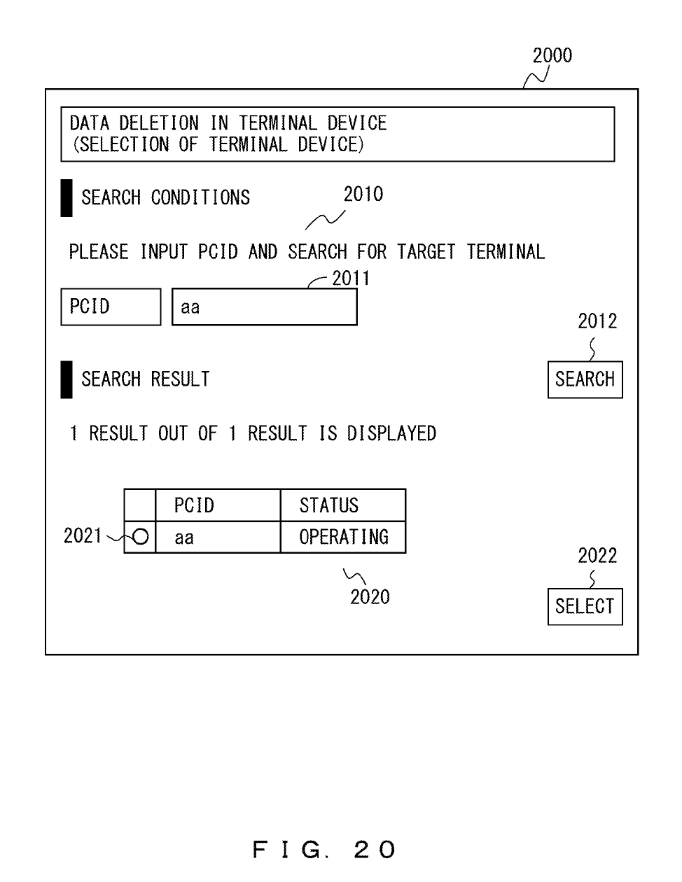

The management server 510 provides a WEB page for managing the terminal device 520. For example, the management server 510 provides a WEB page 2000 illustrated in FIG. 20. When, for example, an administrator accesses the WEB page 2000 through an administrator terminal 530 so as to input the PCID of the terminal device 520 of which he or she desires to delete data, the management server 510 refers to the terminal management information 900 so as to search for a terminal device 520 having a PCID identical to the input PCID. The management server 510 displays the search result on the WEB page 2000 in a selectable manner. The administrator uses the administrator terminal 530 so as to select the terminal device 520 of which he or she desires to delete data from among the search results. Then, the management server 510 establishes a communication line of the PSN corresponding to the PCID of the selected terminal device 520, and instructs the terminal device 520 to delete data through the established communication line. In such a case, the 520 that has been instructed to delete data deletes data stored in the HDD 630 included in the terminal device 520. As described above, in a case in which the terminal device 520 has been stolen or lost or other such cases, the administrator can delete data stored in the HDD of the desired terminal device 520 through the WEB page 2000. Note that it is possible to lock the reading from or writing to the HDD 630 of the terminal device 520 by performing substantially the same process as the above described data deletion.

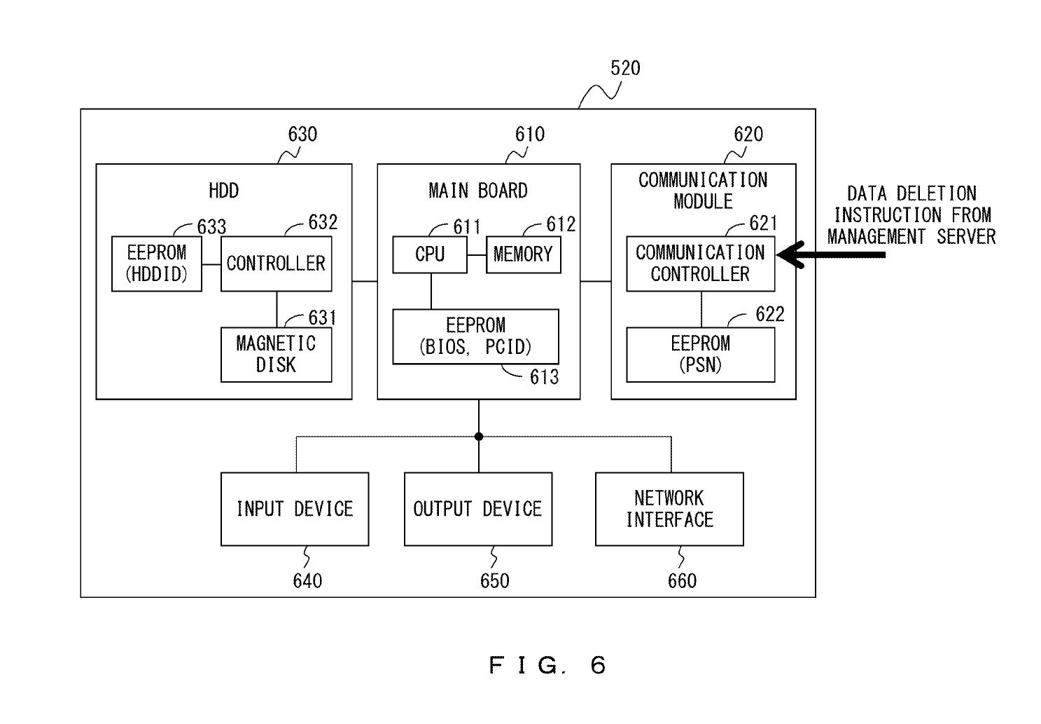

FIG. 6 illustrates an example of a configuration of the terminal device 520. The terminal device 520 includes the main board 610, the communication module 620, the HDD 630, an input device 640, an output device 650, and a network interface 660.

The main board 610 is aboard for mounting principal devices included in the terminal device 520. The main board 610 may include, for example, a CPU (Central Processing Unit) 611, a memory 612, an EEPROM (Electrically Erasable Read Only Memory) 613, etc.

The CPU 611 is a computation unit that executes the OS (Operating System), application programs, and the BIOS (Basic Input/Output System) stored in the EEPROM 613. When the BIOS is executed upon the activation of the terminal device 520, the BIOS reads the PCID from a specified area of the EEPROM 613 in the main board 610. Also, the bios obtains the PSN stored in an EEPROM 622 in the communication module 620. Further, the BIOS obtains the HDDID stored in an EEPROM 633 in the HDD 630. Then, the BIOS reports to the management server 510 the terminal information 800 including the PCID, the PSN, and the HDDID by using the network interface 660.

The memory 612 is a storage device that stores a program or the like executed by the CPU 611. For the memory 612, a volatile memory such as, a RAM (Random Access Memory) may be used.

The EEPROM 613 is a non-volatile memory that stores the BIOS etc. In the EEPROM 613, a PCID, which is identification information for identifying the terminal device 520 including the main board 610, is stored. A PCID is used for identifying the terminal device 520, and accordingly even when the main board 610 has been replaced for maintenance, a PCID identical to the PCID stored in the EEPROM 613 of the main board before the replacement has to be stored in the EEPROM 613 of the main board 610 after the replacement. The operation of setting the PCID stored in the EEPROM 613 of the main board before the replacement to the EEPROM 613 of the main board 610 after the replacement is conducted by a CE during the maintenance operation.

The communication module 620 may include a communication controller 621, the EEPROM 622, or the like. The communication controller 621 is an interface that establishes a telephone line with the management server 510 or the like so as to perform communication. Also, the communication controller 621 reads a PSN stored in the EEPROM 622 in response to a request from the BIOS so as to report the PSN to the BIOS. An EEPROM 622 can store a PSN that is the telephone number of the communication module 620.

The HDD 630 is a storage device that stores data etc. The HDD 630 is managed by the management server 510. Accordingly, the terminal device 520 may include a HDD other than the HDD 630. Also, the HDD 630 may be provided with an encryption function that encrypts data to store the encrypted data in the HDD 630. The HDD 630 may include a magnetic disk 631, a controller 632, the EEPROM 633, and the like.

The controller 632 is a control device that controls writing of data to and reading of data from the magnetic disk 631. The controller 632 reads a HDDID stored in the EEPROM 633 so as to report the HDDID to the BIOS in accordance with a request from the BIOS. The EEPROM 633 may store a HDDID that is identification information for identifying the HDD 630.

The input device 640 is an input device such as, for example, a keyboard, a mouse, etc. The output device 650 is a device that outputs to a display device data output from the CPU 611. However, the output device 650 may include the display device. The network interface 660 is a device that can be connected to the management server 510 etc. in such a manner that communications can be performed through a network.

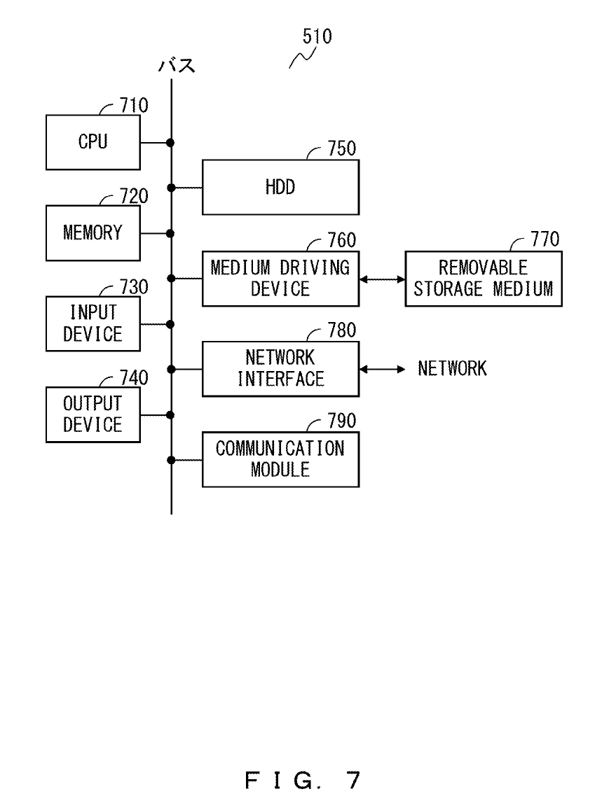

FIG. 7 illustrates an example of a configuration of the management server 510. The management server 510 illustrated in FIG. 7 includes a CPU 710, a memory 720, an input device 730, an output device 740, a HDD 750, a medium driving device 760, a network interface 780, and a communication module 790. These units are connected to a bus so that they can transmit data to and receive data from each other.

The CPU 710 is a computation device that executes a program etc. for implementing the management server 510 according to the present embodiment in addition to executing peripheral devices and various types of software. The memory 720 is a volatile storage device used for storing part or all of the programs executed by the CPU 710. For the memory 720, a RAM or the like for example may be used.

The input device 730 is a unit that inputs data from external circumstances. For the input device 730, for example, a keyboard, a mouse, etc. may be used. The output device 740 is a unit that outputs data or the like to a display device, etc. The output device 740 may include a display device.

The HDD 750 is a non-volatile storage device that stores programs or the like to implement the management server 510 according to the present embodiment in addition to programs or data necessary for the management server 510 to operate. The medium driving device 760 is a device that outputs data in the memory 720 or the HDD 750 to a removable storage medium 770, e.g., a flexible disk, an MO disk, a CD-R, a DVD-R, or the like, or reads programs, data, or the like from the removable storage medium 770.

The network interface 780 is a device that is connected to a network. The communication module 790 uses a PSN to make calls so as to establish a telephone line. The management server 510 can use this communication module 790 to perform communication with the terminal device 520.

Note that non-transitory media may be used for storage media that can be read by an information processing apparatus such as the memory 720, the HDD 750, and the removable storage medium 770, etc. The configuration illustrated in FIG. 7 is an example of a configuration of the management server 510. This example is not used in the sense of limiting the management server 510 to the configuration illustrated in FIG. 7. The management server 510 may include part or all of the elements illustrated in FIG. 7, and may also include other elements not illustrated in FIG. 7.

FIG. 8 illustrates an example of the terminal information 800. The terminal information 800 may include the PCID, the PSN, and the HDDID that are respectively stored in the main board 610, the communication module 620, and the HDD 630 in the terminal device 520.

FIG. 9 illustrates an example of the terminal management information 900. The terminal management information 900 includes terminal information of each terminal device. For example, the terminal management information 900 may include, for each PCID, the PSN and the HDDID that correspond to the PCID as illustrated in FIG. 9.

FIG. 10 explains the outline of a maintenance operation of the terminal device 520 in the information processing system 500. “(1)” through “(11)” in FIG. 10 correspond to (1) through (11) described below.

(1) A CE replaces a maintenance target component, which needs to be replaced for maintenance, in the terminal device 520. A maintenance target component is a component to be managed by the management server 510 by using the terminal management information 900. When, for example, a maintenance target component such as the main board 610, the communication module 620, the HDD 630, or the like in the terminal device 520 has failed, the failed maintenance target component is replaced with a new component.

(2) When the main board 610 has been replaced for maintenance, the CE sets the PCID of the old main board 610 (a main board used before the maintenance operation) to the new main board 610 (a main board to be used after the maintenance operation).

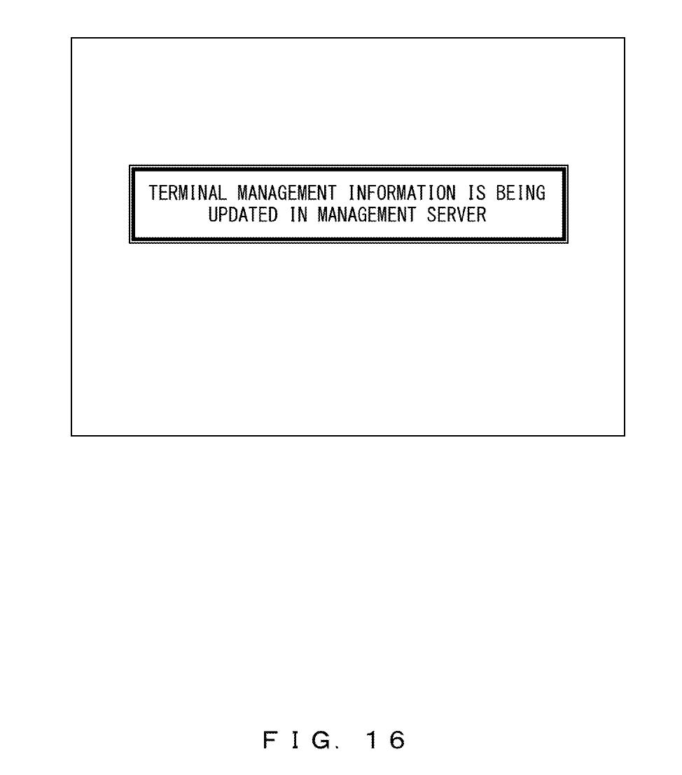

(3) When the terminal device 520 is activated, the BIOS confirms whether or not replacement was conducted for maintenance target components. The BIOS can determine that replacement of a maintenance target component was conducted when, for example, there is an inconsistency between the serial numbers of maintenance target components stored in the HDD 630 or the like and the serial numbers read from the maintenance target components upon the activation of the terminal device 520. In such a case, the BIOS updates the serial number of the maintenance target component stored in the HDD 630 when the terminal management information 900 is normally updated in the management server 510 to the serial number read from the maintenance target component upon the activation of the terminal device 520. When the BIOS has detected that replacement of a maintenance target component was conducted, the BIOS transmits the terminal information 800 to the management server 510 so as to make a request to update the terminal management information 900. In such a case, the BIOS displays a message illustrated in FIG. 16 on the display device.

(4) When the management server 510 has received a request to update the terminal management information 900 from the terminal device 520, the management server 510 performs an update process of the terminal management information 900 in which the contents of the terminal information 800 received from the terminal device 520 are reflected in the terminal management information 900. Explanations will later be given for specific processes of this update process of the terminal management information 900 in FIG. 11.

(5) When the management server 510 determines that there is a wrong PCID in the update process of the terminal management information 900, the management server 510 requests the terminal device 520 to reconfirm the PCID.

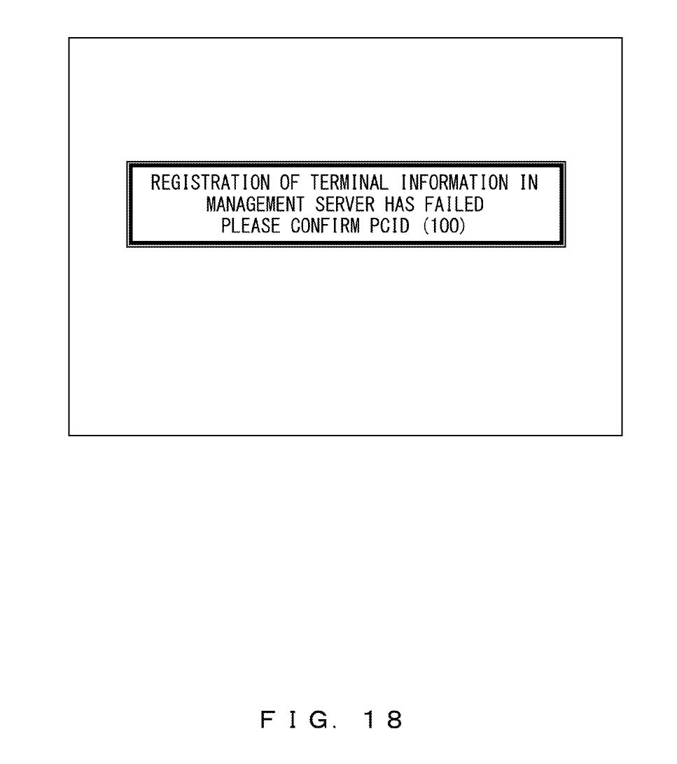

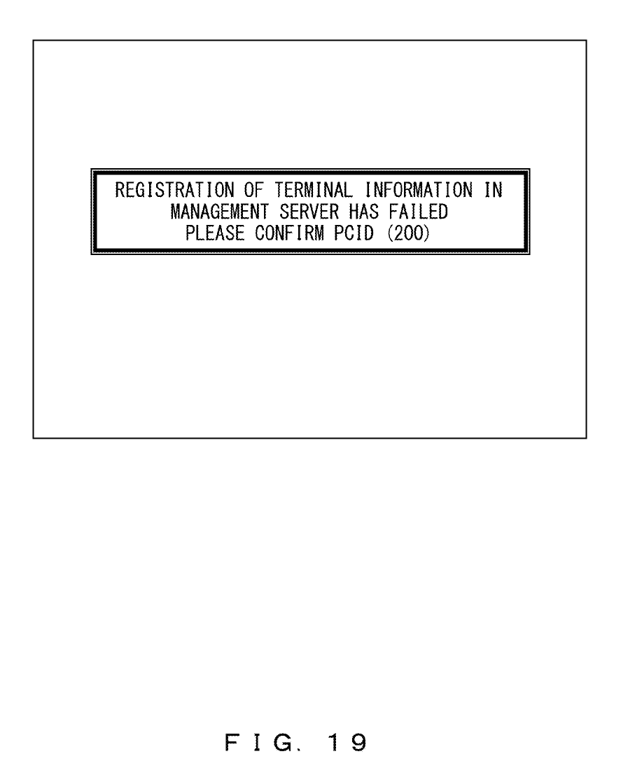

(6) The terminal device 520 that has been requested to reconfirm the PCID displays a message to reconfirm the PCID, e.g., the message illustrated in FIG. 18 or FIG. 19 in the display device, so as to prompt the CE to reconfirm the PCID.

(7) The CE sets the PCID again.

(8) When the terminal device 520 is activated after the PCID was set again, the BIOS confirms whether or not replacement of a maintenance target component was conducted upon the activation of the terminal device 520. When it has been detected that replacement of a maintenance target component was conducted, the BIOS transmits the terminal information 800 to the management server 510 so as to make a request to update the terminal management information 900.

(9) Having received the request to update the terminal management information 900 from the terminal device 520, the management server 510 performs an update process on the terminal management information 900 in which the contents of the terminal information 800 received from the terminal device 520 are reflected in the terminal management information 900.

(10) When the update process of the terminal management information 900 has been terminated normally, the management server 510 reports the normal termination of the update process of the terminal management information 900 to the terminal device 520.

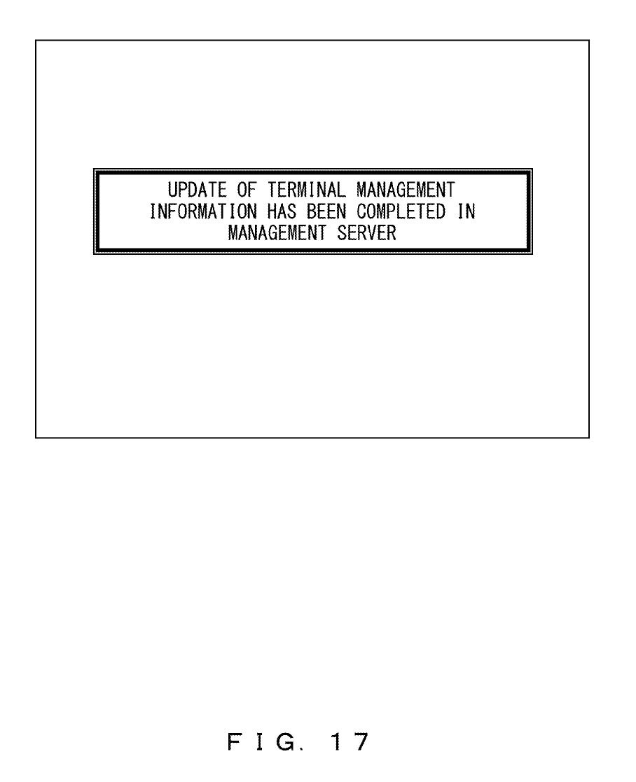

(11) Having received the report of normal termination of the update process of the terminal management information 900 from the management server 510, the terminal device 520 displays a message such as illustrated in FIG. 17 indicating the normal termination of the update process of the terminal management information 900, so as to report the normal termination to the CE.

FIG. 11 illustrates an example of an update process of the terminal management information 900. Having received the request to update the terminal management information 900 from the terminal device 520, the management server 510 starts an update process of the terminal management information 900 (step S1100).

The management server 510 refers to the terminal management information 900 so as to confirm whether or not the PCID included in the terminal information 800 received together with the update request from the terminal device 520 (referred to as a “received PCID” hereinafter) exists in the terminal management information 900 (step S1101).

When the terminal management information 900 includes the received PCID (Yes in step S1101), the process of the management server 510 moves to step S1102. In such a case, the management server 510 confirms whether or not the terminal management information 900 includes a PSN that is identical to the PSN included in the terminal information 800 received from the terminal device 520 (referred to as a “received PSN” hereinafter) and that corresponds to a PCID other than the received PCID (step S1102).

When the terminal management information 900 does not include a PSN that is identical to the received PSN and that corresponds to a PCID other than the received PCID (No in step S1102), the process of the management server 510 moves to step S1103. In such a case, the management server 510 confirms whether or not the terminal management information 900 includes a HDDID that is identical to the HDDID included in the terminal information 800 received from the terminal device 520 (referred to as a “received HDDID” hereinafter) and that corresponds to a PCID other than the received PCID (step S1103). Hereinafter, a HDDID in terminal management information 900 that is identical to the received HDDID and that corresponds to a PCID other than the received PCID is referred to as a “duplicated HDDID”.

When there is a duplicated HDDID (Yes in step S1103), the process of the management server 510 moves to step S1104. In such a case, the management server 510 issues and transmits a confirmation command to the terminal device specified by the PCID corresponding to the duplicated HDDID in the terminal management information 900. Then the management server 510 confirms whether or not there is a response from the specified terminal device (step S1104). This confirmation command is a command that only makes a call by using a PSN. In step S1104, the PSN, which is associated with the PCID corresponding to the duplicated HDDID, among PSNs included in the terminal management information 900, is used to make a call.

When there is a response to the confirmation command (YES in step S1104), the management server 510 transmits a request to update the terminal information to the terminal device that made the response (step S1105). Thereafter, the process of the management server 510 moves to step S1106. When a duplicated HDDID does not exist (NO in step S1103), steps S1104 and S1105 are skipped and the process of the management server 510 moves to step S1106.

The management server 510 reflects, in the terminal management information 900, the contents of the terminal information 800 received from the terminal device 520 so as to update the terminal management information 900 (step S1106). Thereafter, the management server 510 reports to the terminal device 520 that the update process of the terminal management information 900 has been terminated normally (step S1107).

When the terminal management information 900 does not include the received PCID (NO in step S1101), the process of the management server 510 moves to step S1108. When the terminal management information 900 includes a PSN that is identical to the received PSN and that corresponds to a PCID other than the received PCID (YES in step S1102), the process of the management server 510 also moves to step S1108. In such a case, the management server 510 determines that the PCID included in the terminal information 800 received from the terminal device 520 is wrong, and discards the terminal information 800 (step S1108). Thereafter, the management server 510 requests that the terminal device 520 reconfirm the PCID (step S1109). Having received the request to reconfirm the PCID from the management server 510, the terminal device 520 displays, for example, a message illustrated in FIG. 18 to a display device.

When there is no response to the confirmation command (NO in step S1104), the process of the management server 510 moves to step S1110. In such a case, the management server 510 does not determine whether the received PCID included in the terminal information 800 received from the terminal device 520 is correct or wrong. Thus, the management server 510 discards the received terminal information 800 (step S1110). Thereafter, the management server 510 requests that the terminal device 520 reconfirm the PCID (step S1111). Having received the request to reconfirm the PCID from the management server 510, the terminal device 520 displays, for example, a message illustrated in FIG. 19 to a display device. The massages are different between FIG. 18 and FIG. 19, “100” in FIG. 18 and “200” in FIG. 19. This is for making a CE or the like recognize causes or types of errors.

Hereinafter, explanations will be given for specific cases of the update process of the terminal management information 900 illustrated in FIG. 11. In the explanations below, it is assumed that the terminal information of terminal device A and the terminal information of terminal device B are registered in the terminal management information 900 stored in the management server 510. It is also assumed that terminal device A before a maintenance operation or before replacement of HDDs between terminal devices has “aa” as a PCID, “11” as a HDDID, and “070-0000-0001” as a PSN. Similarly, terminal device B before a maintenance operation or before replacement of HDDs between terminal devices has “bb” as a PCID, “22” as a HDDID, and “070-0000-0002” as a PSN. Further, it is also assumed that a CE has replaced both the main board and the communication module of terminal device A for maintenance.

Case 1: Both the main board and the communication module of terminal device A have been replaced for maintenance. However, a wrong PCID has been set in the new main board of terminal device A. The wrong PCID (which has been set in the new main board) has already been set in the main board of terminal device B.

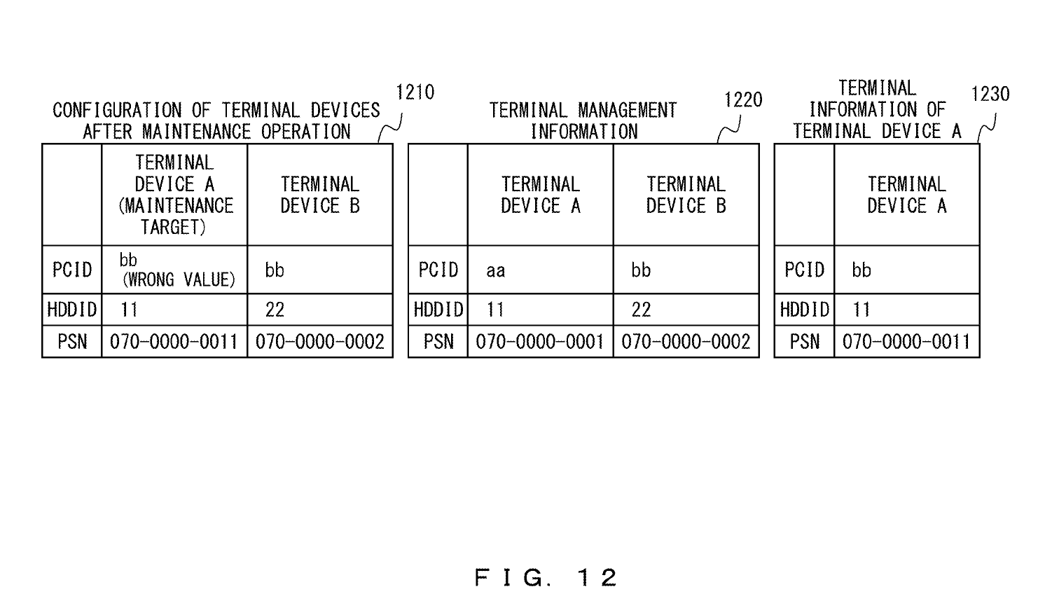

FIG. 12 illustrates the configurations of terminal devices A and B, the terminal management information 1220 stored in the management server 510, and the terminal information 1230 received from terminal device A with respect to case 1. The table 1210 represents configurations of terminal devices A and B after maintenance operation. The terminal management information 1220 has not been updated with respect to maintenance operation.

In case 1, when the main board of terminal device A is replaced for maintenance, the CE has set a wrong PCID in the new main board. Accordingly, the PCID of terminal device A, which was inherently “aa”, has been changed to “bb”, as represented by table 1210.

The communication module of terminal device A has also been replaced for maintenance. Accordingly, the PSN of terminal device A has been changed from “070-0000-0001”, which had been set in the communication module before the maintenance, to “070-0000-0011”, which is set in the new communication module after the maintenance.

The terminal management information 1220 illustrated in FIG. 12 represents contents before update with respect to the maintenance. Thus, the terminal information of terminal device A before the maintenance operation (PCID: aa, HDDID: 11, PSN: 070-0000-0001) and the terminal information of terminal device B before the maintenance operation (PCID: bb, HDDID: 22, PSN: 070-0000-0002) are registered in the terminal management information 1220.

When terminal device A in the state as represented by the table 1210 is activated, terminal device A transmits the terminal information 1230 to the management server 510 so as to request that the management server 510 update the terminal management information 1220. When the management server 510 receives the request to update the terminal management information 1220, the management server 510 executes an update process on the terminal management information 1220 in accordance with the flowchart illustrated in FIG. 11.

Step S1101: A PCID that is identical to the received PCID “bb” included in the terminal information 1230, i.e., the PCID of terminal device B in the example of FIG. 12, exists in the terminal management information 1220 (YES in step S1101). In such a case, the process of the management server 510 moves to step S1102.

Step S1102: The PSN that is identical to the received PSN “070-0000-0011” included in the terminal information 1230 and that corresponds to a PCID other than the received PCID “bb” does not exist in the terminal management information 1220 (NO in step S1102). In such a case, the process of the management server 510 moves to step S1103.

Step S1103: A HDDID that is identical to the received HDDID “11” included in the terminal information 1230 and that corresponds to PCID “aa”, which is different from the received PCID “bb”, exists in the terminal management information 1220 (YES in step S1103). In such a case, the process of the management server 510 moves to step S1104.

Step S1104: The management server 510 transmits a confirmation command by using PSN “070-0000-0001” to terminal device A specified by PCID “aa” corresponding to HDDID “11” that is decided to be duplicated in the terminal management information 1220. However, actually, as illustrated in the table 1210, the communication module of terminal device A has already been replaced in the maintenance operation, and terminal device does not receive the confirmation command. Thus, the management server 510 does not receive a response from terminal A (NO in step S1104). In such a case, the management server 510 decides that the terminal information 1230 received from terminal A includes error. Then the management server 510 discards the terminal information 1230 received from terminal device A (step S1110), and requests that terminal device A reconfirm the PCID (step S1111).

Case 2: The HDDs have been switched between terminal devices A and B by a user. In addition, both the main board and the communication module of terminal device A have been replaced for maintenance. However, the terminal management information 900 stored in the management server 510 has not been updated.

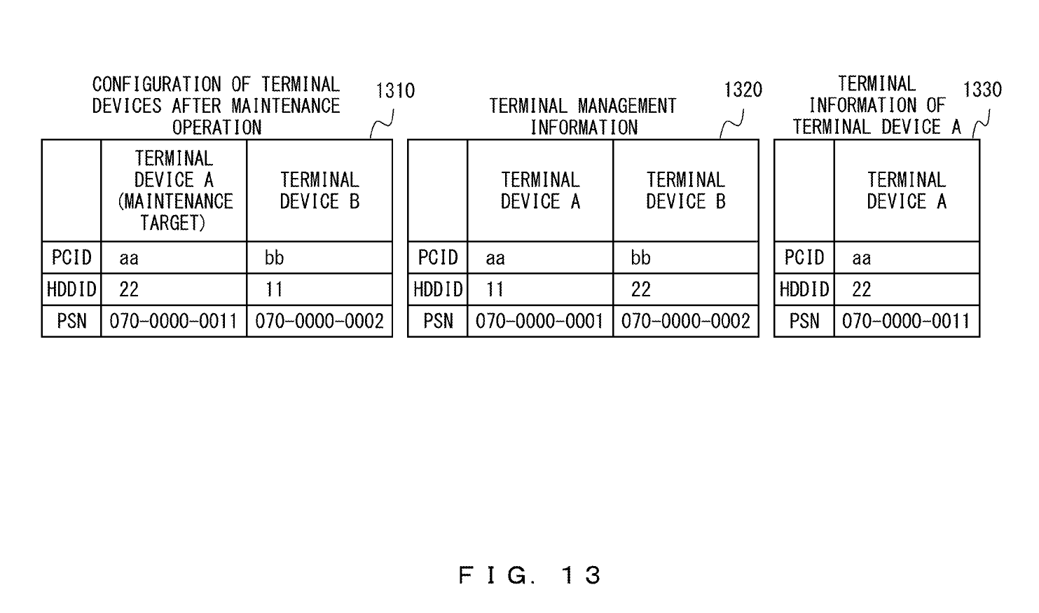

FIG. 13 illustrates the configurations of terminal devices A and B, the terminal management information 1320 stored in the management server 510, and the terminal information 1330 received from terminal device A with respect to case 2. The table 1310 represents configurations of terminal devices A and B after HDDs were switched between terminal devices A and B and the maintenance operation.

In case 2, the HDDs of terminal devices A and B have been switched by a user. Accordingly, as illustrated in the table 1310, the HDD having HDDID “22”, which was mounted on terminal device B, is mounted on terminal device A, while the HDD having HDDID “11”, which was mounted on terminal device A, is mounted on terminal device B.

When the main board of terminal device A was replaced for maintenance, the CE has properly set the PCID that was set in the main board before the maintenance replacement. Accordingly, as illustrated in the table 1310, the PCID of terminal device A, which was “aa” before the maintenance replacement, has properly been inherited by the PCID after the maintenance replacement.

The communication module of terminal device A has been replaced for maintenance. Accordingly, as illustrated in the table 1310, the PSN of terminal device A has been changed from “070-0000-0001”, which was set in the communication module before the maintenance replacement, to “070-0000-00011”, which is set in the communication module after the maintenance replacement.

The terminal information of terminal device A before the replacement of the HDDs (PCID: aa, HDDID: 11, PSN: 070-0000-0001) and the terminal information of terminal device B before the replacement of the HDDs are registered in the terminal management information 1320.

When terminal device A in the state as represented by the table 1310 is activated, terminal device A transmits the terminal information 1330 to the management server 510 so as to request that the management server 510 update the terminal management information 1320. When the management server 510 receives the request to update the terminal management information 1320, the management server 510 executes the update process on the terminal management information 1320 in accordance with the flowchart illustrated in FIG. 11.

Step S1101: A PCID that is identical to the received PCID “aa” included in the terminal information 1330, i.e., the PCID of the terminal device A in the example of FIG. 13, exists in the terminal management information 1320 (YES in step S1101). In such a case, the process of the management server 510 moves to step S1102.

Step S1102: The PSN that is identical to the received PSN “070-0000-0011” included in the terminal information 1330 and corresponds to a PCID that is other than the received PCID “aa” does not exist in the terminal management information 1320 (NO in step S1102). In such a case, the process of the management server 510 moves to step S1103.

Step S1103: A HDDID that is identical to the received HDDID “22” included in the terminal information 1330 and that corresponds to PCID “bb”, which is different from the received PCID “aa”, exists in the terminal management information 1320 (YES in step S1103). In such a case, the process of the management server 510 moves to step S1104.

Step S1104: The management server 510 transmits a confirmation command by using PSN “070-0000-0002” to terminal device B specified by PCID “bb” corresponding to HDDID “22” that is decided to be duplicated in the terminal management information 1320. At this time, as illustrated in the table 1310, since the communication module having PSN “070-0000-0002” has been mounted on terminal device B, terminal B receives the confirmation command and responds to the command. Thus, the management server 510 receives a response to the confirmation command from terminal device B (YES in step S1104). In such a case, the process of the management server 510 moves to step S1105.

The management server 510 transmits a request to update the terminal information (HDDID) to terminal device B (step S1105). This request may be realized by transmitting an e-mail to the address used by the user of terminal device B. Thereafter, the management server 510 reflects the contents of the terminal information 1330 received from terminal device A in the terminal management information 1320 (step S1106). Then the management server 510 transmits, to terminal device A, a report that the update process of the terminal management information 1320 has been terminated (step S1107).

Note that when communication is prevented due to the reason that the communication module having PSN “070-0000-0002” is out of the communication area or for other reasons, the management server 510 fails to receive the response to the confirmation command from terminal device B (NO in step S1104). In such a case, the management server 510 discards the terminal information 1330 received from terminal device A (step S1110), and requests that terminal device A reconfirm the PCID (step S1111). Having received the request to reconfirm the PCID from the management server 510, terminal device A displays, for example, a message illustrated in FIG. 19 on a display device so as to prompt the CE to reconfirm the PCID.

In case 2, the PCID is not wrong, that is, the PCID has been correctly set in the main board. Thus, the CE confirms whether or not a HDD has been replaced by the user by asking the user or checking the maintenance history. In addition, since the request to update the terminal information (HDDID) is transmitted from the maintenance server 510 to terminal device B, the CE may check the request. Then, the CE may implement the HDD back to the original terminal device or may perform a maintenance operation of replacing the HDD with a maintenance HDD or other operations. After that terminal device A transmits the terminal information 1330 to the management server 510.

Case 3: The HDDs have been switched between terminal devices A and B by a user. In addition, both the main board and the communication module of terminal device A have been replaced for maintenance. However, only the terminal management information 900 of terminal A in the management server 510 has been updated.

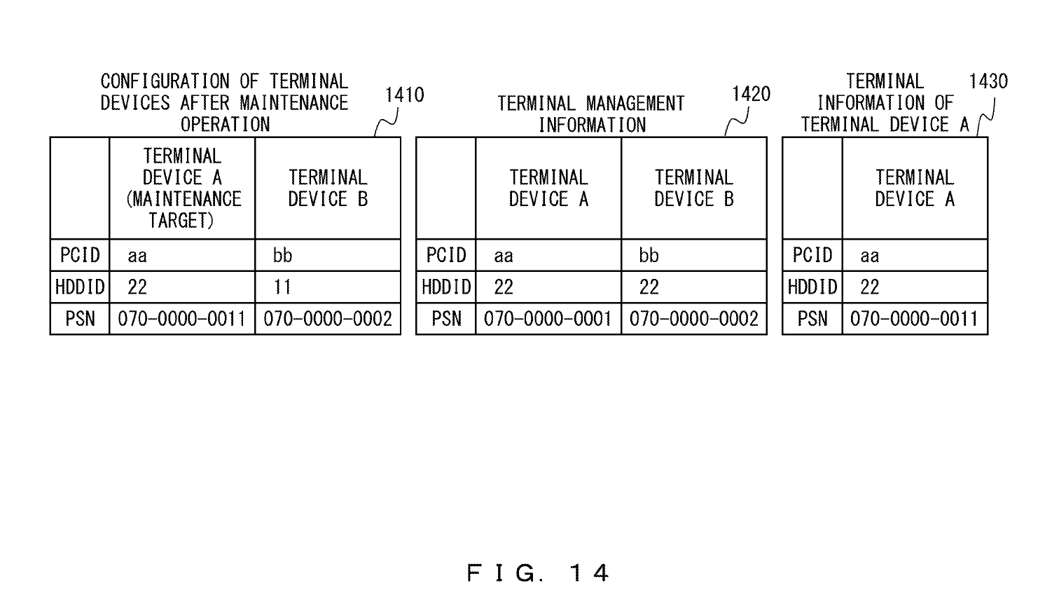

FIG. 14 illustrates the configurations of terminal devices A and B, the terminal management information 1420 stored in the management server 510, and the terminal information 1430 received from terminal device A with respect to case 3. The table 1410 represents configurations of terminal devices A and B after HDDs were switched between terminal devices A and B and the maintenance operation.

In case 3, the HDD of terminal device A and the HDD of terminal device B have been switched by a user. Accordingly, as represented by the table 1410, the HDD having HDDID “22”, which was mounted on terminal device B, is mounted on terminal device A, while the HDD having HDDID “11”, which was mounted on terminal device A, is mounted on terminal device B.

When the main board of terminal device A was replaced for maintenance, the CE has properly set the PCID that was set in the main board before the maintenance replacement. Accordingly, as illustrated in the table 1410, the PCID of terminal device A, which was “aa” before the maintenance replacement, has properly been inherited by the PCID after the maintenance replacement.

The communication module of terminal device A has been replaced for maintenance. Accordingly, as illustrated in the table 1410, the PSN of terminal device A has been changed from “070-0000-0001”, which was set in the communication module before the maintenance replacement, to “070-0000-00011”, which is set in the communication module after the maintenance replacement.

After the switching of the HDDs between terminal devices A and B, the update process of the terminal management information 1420 is conducted for the terminal information of terminal device A. Accordingly, the terminal information of terminal device A after the replacement of the HDDs (PCID: aa, HDDID: 22, PSN: 070-0000-0001) and the terminal information of terminal device B before the replacement of the HDDs (PCID: bb, HDDID: 22, PSN: 070-0000-0002) are registered in the terminal management information 1420.

When terminal device A in the state as represented by the table 1410 is activated, terminal device A transmits the terminal information 1430 to the management server 510 so as to request that the management server 510 update the terminal management information 1420. When the management server 510 receives the request to update the terminal management information 1420, the management server 510 executes the update process on the terminal management information 1420 in accordance with the flowchart illustrated in FIG. 11.

Step S1101: A PCID that is identical to the received PCID “aa” included in the terminal information 1430, i.e., the PCID of terminal device A in the example of FIG. 14, exists in the terminal management information 1420 (YES in step S1101). In such a case, the process of the management server 510 moves to step S1102.

Step S1102: The PSN that is identical to the received PSN “070-0000-0011” included in the terminal information 1430 and that corresponds to a PCID other than the received PCID “aa” does not exist in the terminal management information 1420 (NO in step S1102). In such a case, the process of the management server 510 moves the process proceed to step S1103.

Step S1103: A HDDID that is identical to the received HDDID “22” included in the terminal information 1430 and that correspond to PCID “bb”, which is different from the received PCID “aa”, exists in the terminal management information 1420 (YES in step S1103). In such a case, the process of the management server 510 moves the process proceed to step S1104.

Step S1104: The management server 510 transmits a confirmation command by using PSN “070-0000-0002” to terminal device B specified by PCID “bb” corresponding to HDDID “22” that is decided to be duplicated in the terminal management information 1420. At this time, as illustrated in the table 1410, since the communication module having PSN “070-0000-0002” has been mounted on terminal device B, terminal B receives the confirmation command and responds to the command. Thus, the management server 510 receives a response to the confirmation command from terminal device B (YES in step S1104). In such a case, the process of the management server 510 moves to step S1105.

The management server 510 transmits a request to update the terminal information (HDDID) to terminal device B (step S1105). This request may be realized by transmitting an e-mail to the address used by the user of terminal device B. Thereafter, the management server 510 reflects the contents of the terminal information 1430 received from terminal device A in the terminal management information 1420 (step S1106). Then the management server 510 transmits, to terminal device A, a report that the update process of the terminal management information 1420 has been terminated (step S1107).

In Case 3, since the request to update the terminal information (HDDID) is transmitted from the maintenance server 510 to terminal device B, the CE may realize that the HDD of terminal device B has been replaced by a user. Note that when communication is prevented due to the reason that the communication having PSN of “070-0000-0002” is out of the communication area or for other reasons, the similar processes to case 2 will be performed.

Case 4: The HDDs have been switched between terminal devices A and B by a user. In addition, both the main board and the communication module of terminal device A have been replaced for maintenance. However, only the terminal management information 900 of terminal B in the management server 510 has been updated.

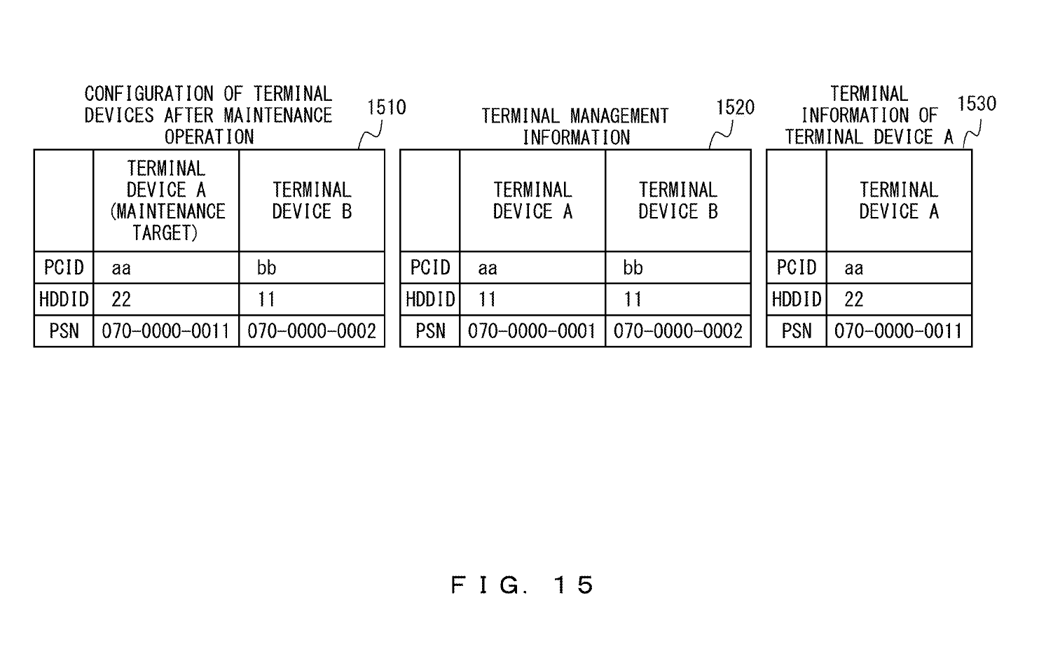

FIG. 15 illustrates the configurations of terminal devices A and B, the terminal management information 1520 stored in the management server 510, and the terminal information 1530 received from terminal device A with respect to case 4. The table 1510 represents configurations of terminal devices A and B after HDDs were switched between terminal devices A and B and the maintenance operation.

In case 4, the HDD of terminal device A and the HDD of terminal device B have been switched by a user. Accordingly, as represented by the table 1510, the HDD having HDDID “22”, which was mounted on terminal device B, is mounted on terminal device A, while the HDD having HDDID “11”, which was mounted on terminal device A, is mounted on terminal device B.

When the main board of terminal device A was replaced for maintenance, the CE has properly set the PCID that was set in the main board before the maintenance replacement. Accordingly, as illustrated in the table 1510, the PCID of terminal device A, which was “aa” before the maintenance replacement, has properly been inherited by the PCID after the maintenance replacement.

The communication module of terminal device A has been replaced for maintenance. Accordingly, as illustrated in the table 1510, the PSN of terminal device A has been changed from “070-0000-0001”, which was set in the communication module before the maintenance replacement, to “070-0000-00011”, which is set in the communication module after the maintenance replacement.

After the switching of the HDDs between terminal devices A and B, the update process of the terminal management information 1520 is conducted for the terminal information of terminal device B. Accordingly, the terminal information of terminal device A before the replacement of the HDDs (PCID: aa, HDDID: 11, PSN: 070-0000-0001) and the terminal information of terminal device B after the replacement of the HDDs (PCID: bb, HDDID: 11, PSN: 070-0000-0002) are registered in the terminal management information 1520.

When terminal device A in the state as represented by the table 1510 is activated, terminal device A transmits the terminal information 1530 to the management server 510 so as to request that the management server 510 update the terminal management information 1520. When the management server 510 receives the request to update the terminal management information 1520, the management server 510 executes an update process on the terminal management information 1520 in accordance with the flowchart illustrated in FIG. 11.

Step S1101: A PCID that is identical to the received PCID “aa” included in the terminal information 1530, i.e., the PCID of terminal device A in the example of FIG. 15, exists in the terminal management information 1520 (YES in step S1101). In such a case, the process of the management server 510 moves to step S1102.

Step S1102: The PSN that is identical to the received PSN “070-0000-0011” included in the terminal information 1530 and that corresponds to a PCID other than the received PCID “aa” does not exist in the terminal management information 1520 (NO in step S1102). In such a case, the process of the management server 510 moves the process proceed to step S1103.

Step S1103: An HDDID that is identical to the received HDDID “22” included in the terminal information 1530 and that corresponds to a PCID other than the received PCID “aa” does not exist in the terminal management information 1520 (NO in step S1103). In such a case, steps S1104 and S1105 are skipped and the process of the management server 510 moves to step S1106. Thereafter, the management server 510 reflects the contents of the terminal information 1530 received from terminal device A in the terminal management information 1520 so as to update the terminal management information 1520 (step S1106). In addition, the management server 510 transmits to terminal device A a report that the updating of the terminal information 1530 has been terminated.

FIG. 16 illustrates an example of a message that the terminal device 520 displays on a display device during a process of updating the terminal management information 900. FIG. 17 illustrates an example of a message that the terminal device 520 displays on the display device when the process of updating the terminal management information 900 has been terminated normally. FIG. 18 and FIG. 19 illustrate examples of messages that the terminal device 520 displays on the display device when the management server 510 has received a request to reconfirm a PCID. The message in FIG. 18 is displayed when the conditions described in step S1101 are false or when the conditions described in step S1102 are true. The message in FIG. 19 is displayed when the conditions described in step S1104 are false.

FIG. 20 illustrates an example of a WEB page 2000 provided by the management server 510. The WEB page 2000 illustrated in FIG. 20 may include a search area 2010 for searching for the terminal device 520 for which data deletion is desired, and a selection area 2020 for selecting the terminal device 520 for which data deletion is performed.

The search area 2010 includes an input box 2011 to input a PCID, and a search button 2012. The selection area 2020 includes a radio button 2021 for selecting a PCID found in a search, and a selection button 2022.

When an administrator or the like accesses the WEB page 2000 by using the administrator terminal 530 so as to input an PCID to the input box 2011 and select the search button 2012, the management server 510 searches the terminal management information 900 for the terminal device 520 having the PCID input to the input box 2011. Then, the terminal device 520 displays a found PCID and the status of the terminal device 520 having that PCID in the selection area 2020. As a status, statuses such as “operating”, “locked”, etc., may be displayed. “Operating” represents that data can be read to the HDD of the terminal device 520, and “locked” represents that data writing to the HDD of the terminal device 520 is prohibited. For these statuses, statuses that that have been obtained beforehand from each terminal device 520 and stored in the HDD 750 of the management server 510 or the like may be used. When an administrator has selected the selection button 2022 after selecting the radio button 2021, the management server 510 instructs the terminal device 520 having the selected PCID to delete the data.

In the management server 510 described above, the HDD 750 may be an example of a storage unit that stores terminal management information including terminal device identification information, communication module identification information, and storage device identification information for each terminal device. A PCID may be an example of terminal device identification information. A PSN may be an example of communication module identification information. A HDDID may be an example of storage device identification information. The terminal management information 900, the terminal management information 1220, and the like may be examples of terminal management information including terminal device identification information, communication module identification information, and storage device identification information for each terminal device.

A reception unit, a determination unit, and an update unit may be implemented by causing a CPU 710 in the management server 510 to execute a specified program. Step S1100 in FIG. 11 may be an example of a process executed by the reception unit. Steps S1103 and S1104 in FIG. 11 may be an example of a process executed by the determination unit. Steps S1106, S1108, and S1110, and the like may be examples of processes executed by the update unit.

As described above, the management server 510 determines whether or not the PCID included in the received terminal information 800 is correct. In this determination, the management server 510 takes into consideration whether or not communication is possible with the terminal device 520 specified by the PCID corresponding to duplicated HDDIDs in the terminal management information 900.

For example, the management server 510 transmits a confirmation command to the terminal device 520 specified by the PCID that corresponds to a duplicated HDDID in the terminal management information 900, and confirms whether or not there is a response (step S1104). When there is no response to the confirmation command (NO in step S1104), the management server 510 determines that the PCID included in the terminal information 800 received from the terminal device 520 is not correct, and discards the terminal information 800 (step S1110). As a result of this, as described by referring to FIG. 12, the management server 510 can determine that the received PCID is not correct even in cases like case 1.

When there is a response to the confirmation command (YES in step S1104), the management server 510 determines that the received PCID included in the terminal information 800 received from the terminal device 520 is correct. As a result of this, as described by referring to FIG. 13 and FIG. 14, the management server 510 can determine that the received PCID is correct even in cases like case 2 or 3.

As described above, according to the management server 510, it is possible to determine whether or not a received PCID included in the terminal information 201 from the terminal device 520 in which both the main board 610 and the communication module 620 have been replaced for maintenance is correct.

The disclosed embodiments relate to a management apparatus that manages information related to a main board, a communication module, and a storage device mounted in each terminal device in a replaceable manner. According to the disclosed embodiments, the management apparatus can determine whether or not identification information of a terminal device set in the main board is correct, even when both the main board and the communication module of the terminal device have been replaced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A management apparatus that manages information related to a plurality of terminal devices, the management apparatus comprising:
a storage unit configured to store terminal management information including, for each of the plurality of terminal devices, terminal device identification information that is included in a main board of a terminal device and that is used for identifying the terminal device, communication module identification information that is included in a communication module of a terminal device and that is used for identifying the communication module, and storage device identification information that is included in a storage device of a terminal device and that is used for identifying the storage device;
a reception unit configured to receive, from one of the plurality of terminal devices, terminal information including terminal device identification information, communication module identification information, and storage device identification information that are included in a main board, a communication module, and a storage device of the terminal device, respectively;
a determination unit configured to determine whether or not terminal device identification information that is included in received terminal information is correct based on whether or not communication that uses communication module identification information of a terminal device including storage device identification information, included in the terminal management information, that is identical to storage device identification information included in the received terminal information and that corresponds to a terminal device other than a terminal device specified by terminal device identification information included in the received terminal information is established; and
an update unit configured to update the terminal management information according to the received terminal information when the determination unit determines that the terminal device identification information included in the received terminal information is correct, and configured to discard the received terminal information when the determination unit determines that the terminal device identification information included in the received terminal information is not correct.

2. The management apparatus according to claim 1, wherein
the determination unit determines that the terminal device identification information included in the received terminal information is not correct when communication with a communication module of a terminal device including storage device identification information, included in the terminal management information, that is identical to storage device identification information included in the received terminal information and that corresponds to a terminal device other than a terminal device specified by terminal device identification information included in the received terminal information is not established.

3. The management apparatus according to claim 1, wherein
the determination unit determines that the terminal device identification information included in the received terminal information is correct when communication with a communication module of a terminal device including storage device identification information, included in the terminal management information, that is identical to storage device identification information included in the received terminal information and that corresponds to a terminal device other than a terminal device specified by terminal device identification information included in the received terminal information is established.

4. The management apparatus according to claim 2, wherein
the determination unit determines that the terminal device identification information included in the received terminal information is correct when storage device identification information, included in the terminal management information, that is identical to storage device identification information included in the received terminal information and that corresponds to a terminal device other than a terminal device specified by terminal device identification information included in the received terminal information does not exist.

5. The management apparatus according to claim 1, further comprising
an instruction unit configured to perform communication with a specified terminal device among terminal devices identified by terminal device identification information included in the terminal management information through a communication line corresponding to communication module identification information of the specified terminal device, and to make an instruction to delete data stored in a storage device identified by storage device identification information of the specified terminal device or to block an access to the storage device.

6. The management apparatus according to claim 1, wherein
the determination unit determines that the terminal device identification information included in the received terminal information is not correct when terminal device identification information that is identical to terminal device identification information included in the received terminal information does not exist in the terminal management information.

7. The management apparatus according to claim 1, wherein
the determination unit determines that the terminal device identification information included in the received terminal information is not correct when communication module identification information that is identical to communication module identification information included in the received terminal information and that corresponds to a terminal device other than a terminal device specified by terminal device identification information included in the received terminal information exists in the terminal management information.

8. A management method for managing information related to a plurality of terminal devices, the method comprising:
receiving, by using a processor, from one of the plurality of terminal devices, terminal information including terminal device identification information to identify a terminal device, communication module identification information to identify a communication module, and storage device identification information to identifying a storage device that are included in a main board, a communication module, and a storage device of the terminal device, respectively;
accessing, by using a processor, to a storage unit having stored terminal management information including, for each of the plurality of terminal devices, the terminal device identification information, the communication module identification information, and the storage device identification information;
determining, by using the processor, whether or not terminal device identification information that is included in the received terminal information is correct based on whether or not communication that uses communication module identification information of a terminal device including storage device identification information, included in the terminal management information, that is identical to storage device identification information included in the received terminal information and that corresponds to a terminal device other than a terminal device specified by terminal device identification information included in the received terminal information is established;
updating, by using the processor, the terminal management information according to the received terminal information when it is determined that terminal device identification information included in the received terminal information is correct; and
discarding, by using the processor, the received terminal information when it is determined that terminal device identification information included in the received terminal information is not correct.

9. A computer-readable recording medium having stored therein a program for causing a computer to execute a management process for managing information related to a plurality of terminal devices, the process comprising:
receiving from one of the plurality of terminal devices, terminal information including terminal device identification information to identify a terminal device, communication module identification information to identify a communication module, and storage device identification information to identifying a storage device that are included in a main board, a communication module, and a storage device of the terminal device, respectively;
accessing to a storage unit having stored terminal management information including, for each of the plurality of terminal devices, the terminal device identification information, the communication module identification information, and the storage device identification information;
determining whether or not terminal device identification information that is included in the received terminal information is correct based on whether or not communication that uses communication module identification information of a terminal device including storage device identification information, included in the terminal management information, that is identical to storage device identification information included in the received terminal information and that corresponds to a terminal device other than a terminal device specified by terminal device identification information included in the received terminal information is established;
updating the terminal management information according to the received terminal information when it is determined that terminal device identification information included in the received terminal information is correct; and
discarding the received terminal information when it is determined that terminal device identification information included in the received terminal information is not correct.
